(19) United States
(12) Patent Application Publication
(10) Pub. No.: US 2024/0114561 A1
(43) Pub. Date: Apr. 4, 2024

(54) MULTIPLE UNIVERSAL SUBSCRIBER IDENTITY MODULE GAP COLLISIONS

(71) Applicant: QUALCOMM Incorporated, San Diego, CA (US)

(72) Inventors: Carlos CABRERA MERCADER, Cardiff, CA (US); Arvind Vardarajan SANTHANAM, San Diego, CA (US); Ozcan OZTURK, San Diego, CA (US); Chu-Hsiang HUANG, San Diego, CA (US); Changhwan PARK, San Diego, CA (US); Prashant SHARMA, San Jose, CA (US)

(21) Appl. No.: 17/958,194

(22) Filed: Sep. 30, 2022

(51) Int. Cl. H04W 74/08; H04W 24/10

(52) U.S. Cl. CPC H04W 74/0858; H04W 24/10; H04W 74/0875

(57) ABSTRACT

Certain aspects of the present disclosure provide techniques for handling collisions between multiple universal subscriber identity module (MUSIM) gaps and measurement gaps (MGs) or other MUSIM gaps. In an exemplary method, a user equipment (UE) detects a collision between a first multiple universal subscriber identity module (MUSIM) gap occasion and at least one of a second MUSIM gap occasion or a measurement gap (MG) occasion; and processes signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion.

### BACKGROUND

### Field of the Disclosure

Aspects of the present disclosure relate to wireless communications, and more particularly, to techniques for handling collisions between multiple universal subscriber identity module (MUSIM) gaps and measurement gaps (MGs) or other MUSIM gaps.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes detecting a collision between a first multiple universal subscriber identity module (MUSIM) gap occasion and at least one of a second MUSIM gap occasion or a measurement gap (MG) occasion; and processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion.

Another aspect provides a method for wireless communication by a network entity. The method includes detecting a collision between a first multiple universal subscriber identity module (MUSIM) gap occasion configured for a user equipment (UE) and at least one of a second MUSIM gap occasion or a measurement gap (MG) occasion configured for the UE; and scheduling communications with the UE during a period excluding the at least one of the first MUSIM gap occasion, the second MUSIM gap occasion, the third MUSIM gap occasion, or the MG occasion.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example set of MG occasions for a UE, according to aspects of the present disclosure.

FIG. 6 depicts an example set of MUSIM gap occasions for a UE, according to aspects of the present disclosure.

FIG. 7 depicts a table of MUSIM gap patterns that may be configured at a UE by a MUSIM gap configuration.

FIG. 8 depicts an example call flow for communications in a network between a UE and a network entity, in accordance with aspects of the present disclosure.

FIGS. 9A and 9B depict example timelines of a MUSIM gap occasion and an MG occasion, in accordance with aspects of the present disclosure.

FIGS. 10A and 10B depict example timelines of a MUSIM gap occasion and an MG occasion that collide, in accordance with aspects of the present disclosure.

FIGS. 11A and 11B depict example timelines of two MUSIM gap occasions that overlap in time, in accordance with aspects of the present disclosure.

FIGS. 12A and 12B depict example timelines of two MUSIM gap occasions that collide without overlapping in time, in accordance with aspects of the present disclosure.

FIG. 13 is a block diagram of an example process of resolving collisions of MUSIM gap occasions, in accordance with aspects of the present disclosure.

FIG. 14 depicts a method for wireless communications.

FIG. 15 depicts a method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for handling collisions (e.g., overlaps in time) between multiple universal subscriber identity module (MUSIM) gaps and measurement gaps (MGs) or other MUSIM gaps.

In typical wireless communications networks, a user equipment (UE) that is equipped with multiple universal subscriber identity modules (SIMS) and is capable of communicating via multiple networks may be configured with one or more MG configurations and one or more MUSIM gap configurations. During the MGs, the UE may cease transmitting and receiving on a currently active network so that the UE can measure other cells (e.g., in preparation for handover to another cell) of the network. During the MUSIM gaps, the UE may cease transmitting and receiving on the currently active network so that the UE can transmit in, receive from, and/or measure another network (e.g., to support communications on the other network) while remaining active on the currently active network.

The MG configuration(s) and MUSIM gap configuration(s) can result in one or more MUSIM gap occasions colliding (e.g., occurring at the same time or overlapping in time). When the MG occasion(s) and MUSIM occasion(s) collide, the UE is typically unable to complete the measurement, transmission, or reception for all of the configured gap occasions and does not have processes for resolving the collision(s).

According to aspects of the present disclosure, a UE may detect when a collision an MUSIM gap occasion, another MUSIM gap occasion, and/or an MG occasion occurs. The UE may determine, based on relative priorities of the MUSIM gap occasion(s) and the MG occasion(s), whether to merge two or more MUSIM gap occasions and/or whether to drop one or more of the MUSIM gap occasions and the MG occasions. During dropped MG occasions and dropped MUSIM gap occasions, the UE can transmit and/or receive signals on the currently active network. A network entity may also detect when a collision an MUSIM gap occasion, another MUSIM gap occasion, and/or an MG occasion occurs for a UE, determine whether the UE will drop one or more of the MUSIM gap occasions and the MG occasions, and schedule communications for the UE during the dropped gap occasions.

By implementing the techniques described herein, UEs can handle or resolve collisions between MUSIM gap occasions and/or MG occasions, enabling more efficient communications for the UEs, as well as utilizing transmission resources that might otherwise go unused (e.g., when a UE drops all MUSIM gap occasions in a collision, but is not scheduled for any communications during the times of the dropped gap occasions).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

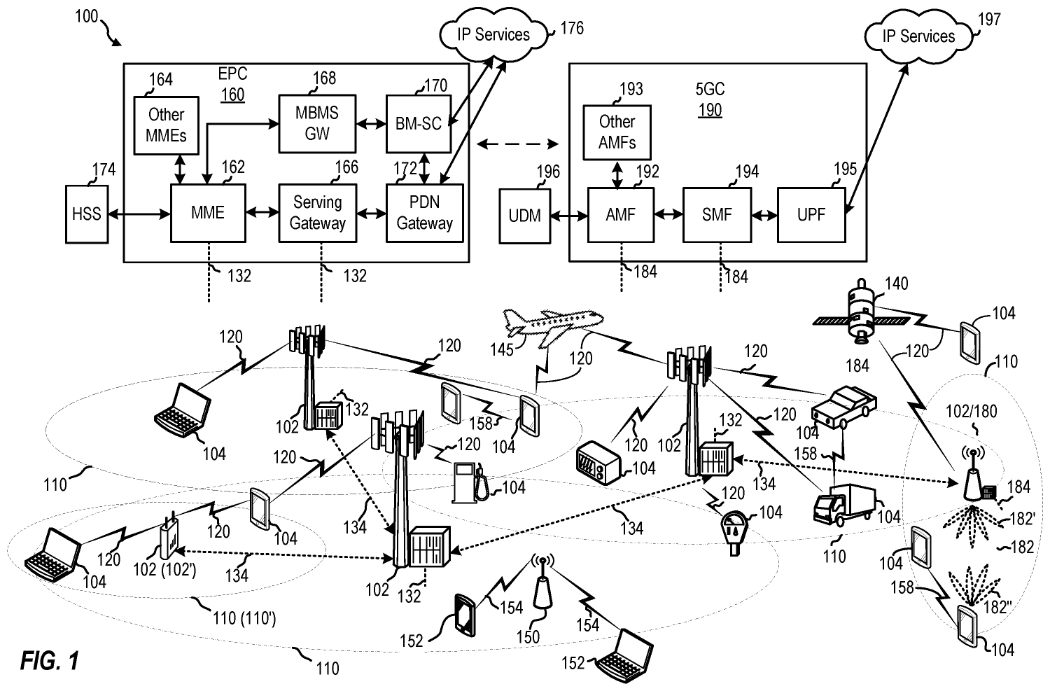

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

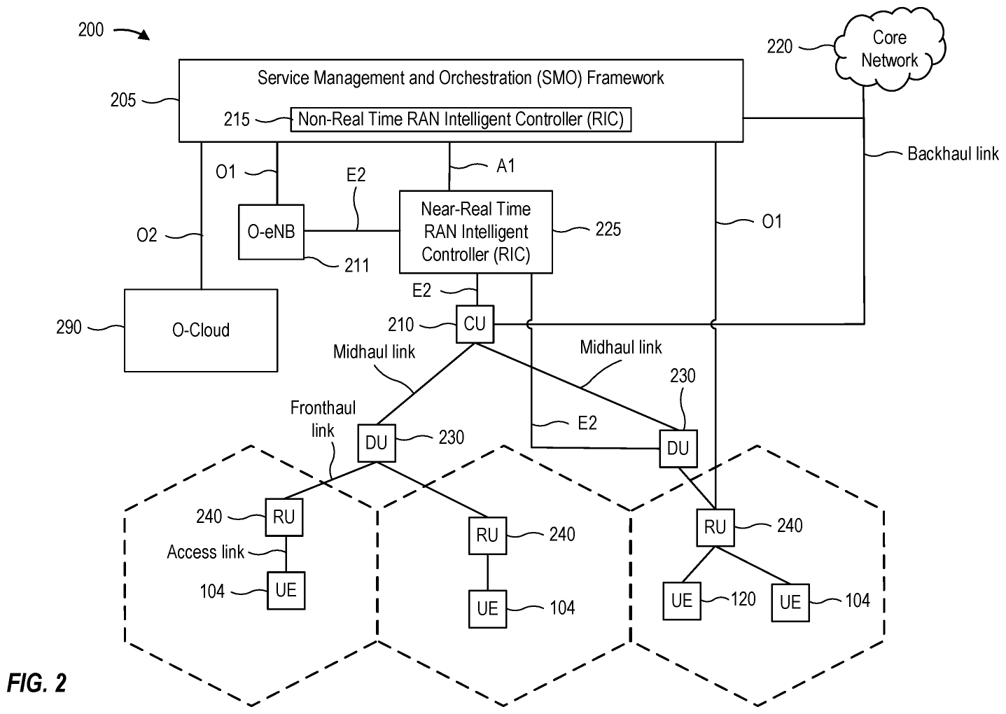

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) MC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (MC) 225 via an E2 link, or a Non-Real Time (Non-RT) MC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240, and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

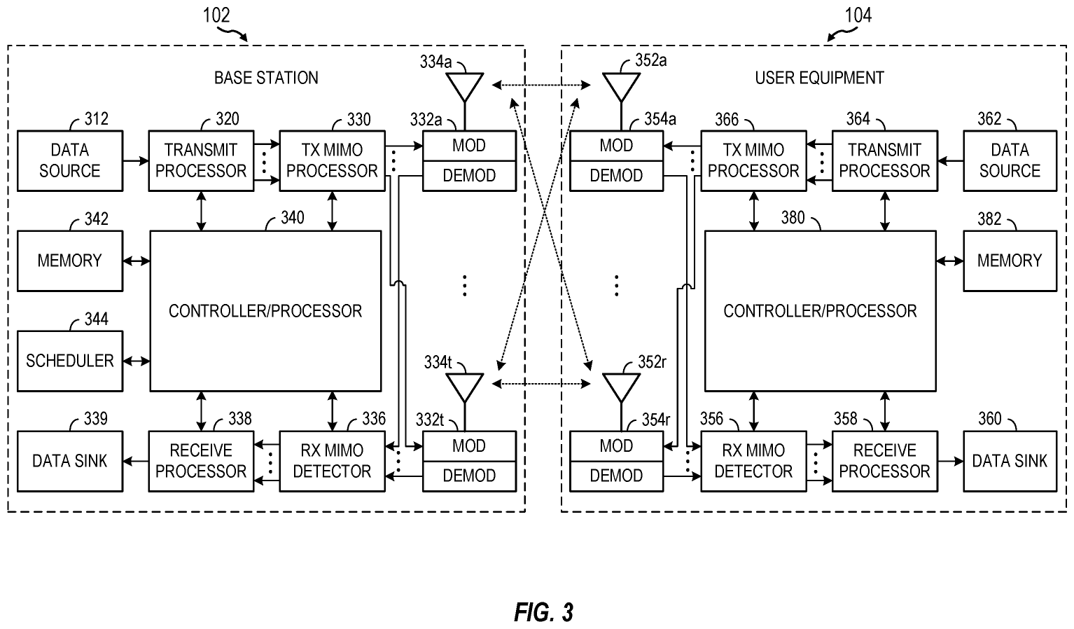

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

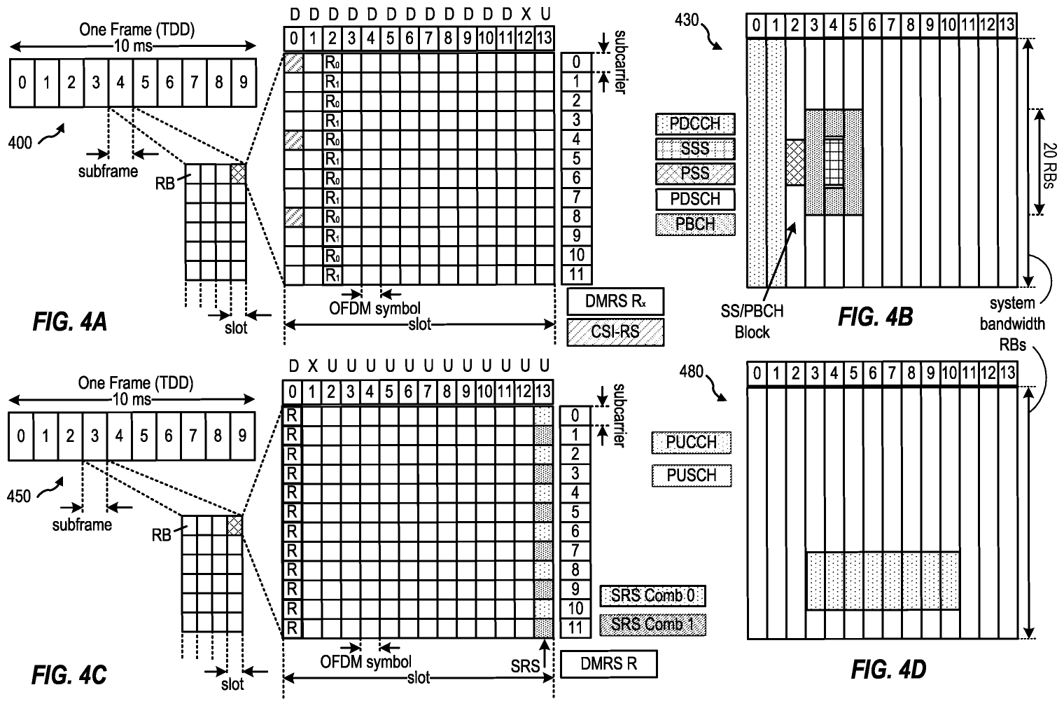

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Measurement Gaps

In aspects of the present disclosure, a UE may be configured with a measurement gap (MG) configuration that configures one or more measurement gap occasions. During the MG occasions, wireless communication between the serving network (e.g., a serving network entity, such as the BS 102 depicted and described with respect to FIGS. 1 and 3 or a node of a disaggregated base station depicted and described with respect to FIG. 2) and the UE are temporarily paused, and the UE may have the opportunity to perform channel measurements of reference signals from other neighboring communication devices (e.g., other BSs, nodes, or UEs). The MG configuration may indicate a periodicity of the MG occasions, a length of the MG occasions, a priority (e.g., relative or absolute priority) of the MG occasions, and/or a time when the MG occasions cease occurring.

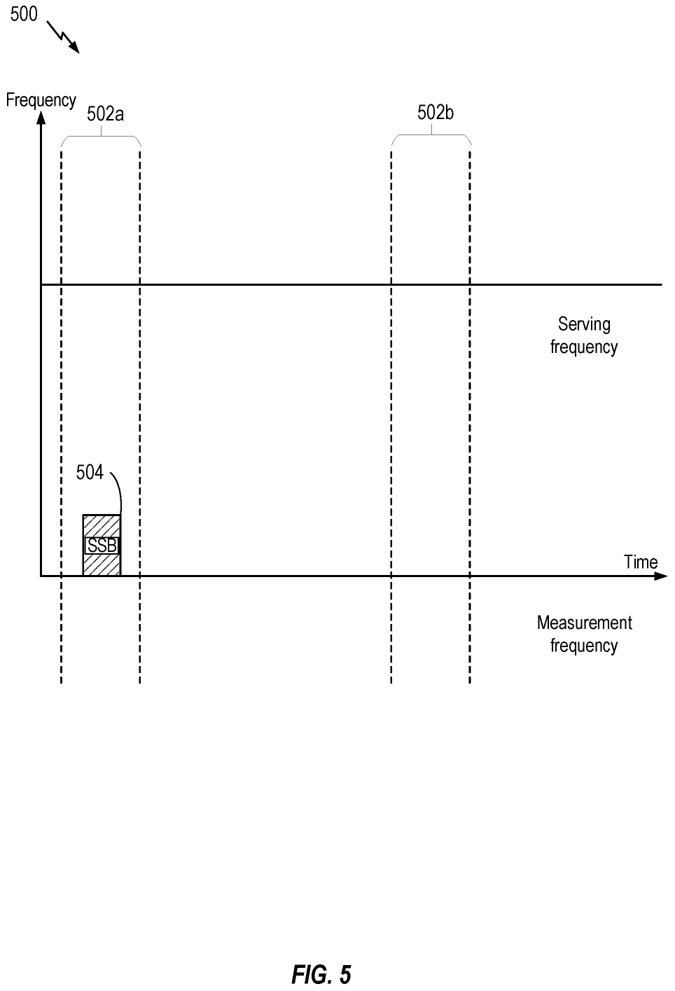

FIG. 5 depicts an example set 500 of MG occasions for a UE, according to aspects of the present disclosure. A UE (e.g., UE 104, depicted and described with respect to FIGS. 1 and 3) may be configured to measure a measurement frequency during MG occasions 502a and 502b. During each of the MG occasions 502, communications with the UE on the serving frequency are paused while the UE measures an SSB 504 and/or other reference signals on the measurement frequency.

### Aspects Related to Multiple Universal Subscriber Identity Module Gaps and Measurement Gaps

In aspects of the present disclosure, a UE may be configured with a MUSIM gap configuration that configures one or more MUSIM gap occasions. During the MUSIM gap occasions, wireless communication between a first network (e.g., an NR network) and the UE are temporarily paused while the UE remains in a connected state in the first network, and the UE may have the opportunity to transmit or receive signals (e.g., to measure reference signals or communicate data) with another network (e.g., another NR network or an LTE network). The MUSIM gap configuration may indicate a periodicity of the MUSIM gap occasions, a length of the MUSIM gap occasions, a priority (e.g., relative or absolute priority) of the MUSIM gap occasions, and/or a time when the MUSIM gap occasions cease occurring.

In aspects of the present disclosure, a UE may be simultaneously configured with up to three periodic MUSIM gaps and one aperiodic MUSIM gap.

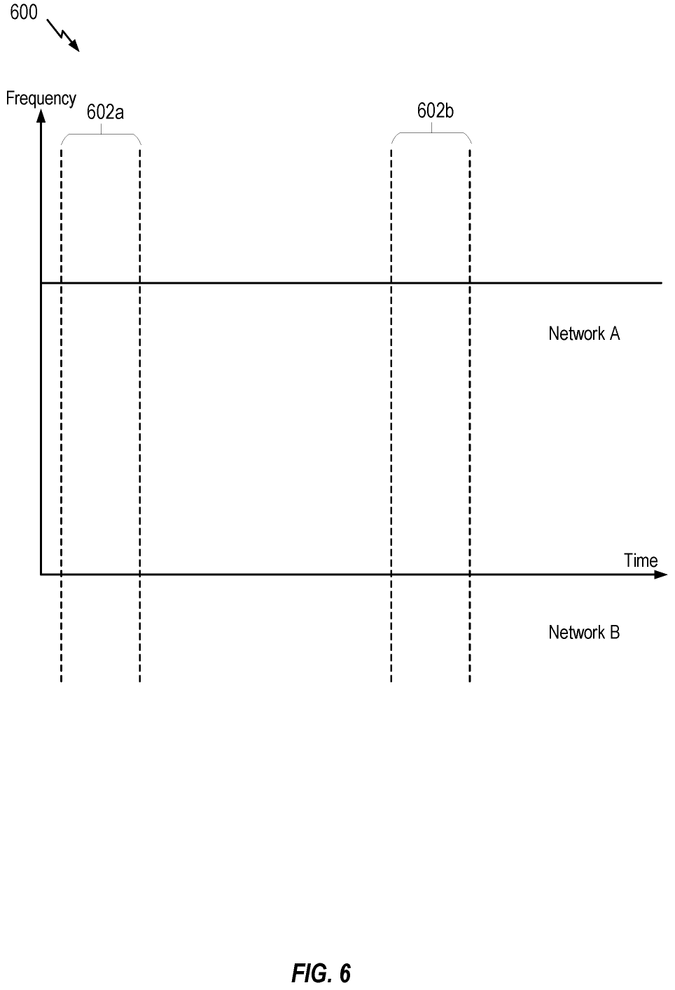

FIG. 6 depicts an example set 600 of MUSIM gap occasions for a UE, according to aspects of the present disclosure. A UE (e.g., UE 104, depicted and described with respect to FIGS. 1 and 3) may be configured to transmit and/or receive signals via network B during MUSIM gap occasions 602a and 602b. During each of the MUSIM gap occasions 602, communications with the UE via network A are paused while the UE measures and/or communicates via network B.

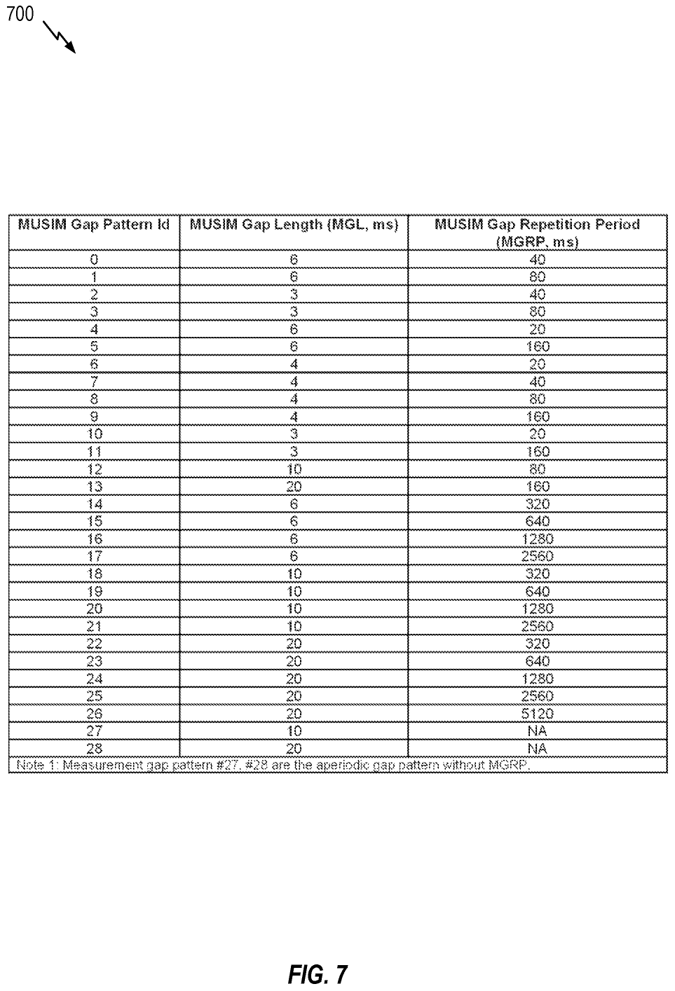

FIG. 7 depicts a table of MUSIM gap patterns that may be configured at a UE by a MUSIM gap configuration. As illustrated, MUSIM gap patterns 0 through 26 are periodic patterns that each include a MUSIM gap length (MGL) and a MUSIM gap repetition period (MGRP). Also as illustrated, MUSIM gap patterns 27 and 28 are aperiodic patterns that each include an MGL and lack an MGRP.

According to aspects of the present disclosure, a UE may have multiple MUSIM gap configurations, which may configure MUSIM gap occasions that collide (e.g., overlap in time) with each other and/or with measurement gaps (MGs) configured at the UE. Accordingly, it is desirable to develop techniques for handling collisions between MUSIM gap occasions and MG occasions or other MUSIM gap occasions.

### Aspects Related to Handling Collisions Between Multiple Universal Subscriber Identity Module Gaps and Measurement Gaps or Other MUSIM Gaps

Aspects of the present disclosure provide techniques for handling collisions between multiple universal subscriber identity module (MUSIM) gap occasions and MG occasions or other MUSIM gap occasions. As used herein, a collision (also referred to as a “conflict”) between a first MUSIM gap occasion and an MG occasion or a second MUSIM gap occasion refers to the first MUSIM gap occasion overlapping in time or occurring within a threshold period of time as the MG occasion or the second MUSIM gap occasion.

As used herein, a “MUSIM gap occasion” may also be referred to as a “MUSIM gap.” Similarly, as used herein and “MG occasion” may also be referred to as an “MG,” a “measurement gap occasion,” a “measurement gap,” an “MG instance,” or a “measurement gap instance.”

In aspects of the present disclosure, when a first MUSIM gap occasion collides with an MG occasion or a second MUSIM gap occasion, a UE and/or a network entity may resolve the collision based on relative priorities assigned to each of the first MUSIM gap occasion, the MG occasion, and the second MUSIM gap occasion.

According to aspects of the present disclosure, each concurrent MG occasion configured on a UE may be assigned a unique priority level. Collisions occur between MG occasions when the two MG instances are separated in time by four milliseconds or less. When a collision between MG occasions occurs, the MG occasion(s) with lower priority are dropped. That is, the UE does not retune to the frequencies scheduled to be measured nor measure those frequencies during the conflicting MG occasion(s) having lower priority.

In aspects of the present disclosure, the network serving a UE specifies the measurements to be measured by the UE in each MG occasion. In typical networks, each ‘frequency layer’ may be associated with one of the concurrent MG occasions. However, CSI-RS and SSBs in non-terrestrial networks (NTNs) may be associated with two concurrent MG occasions. All positioning frequency layers may share one concurrent MG occasion, in typical networks.

### Example Operations of Entities in a Communications Network

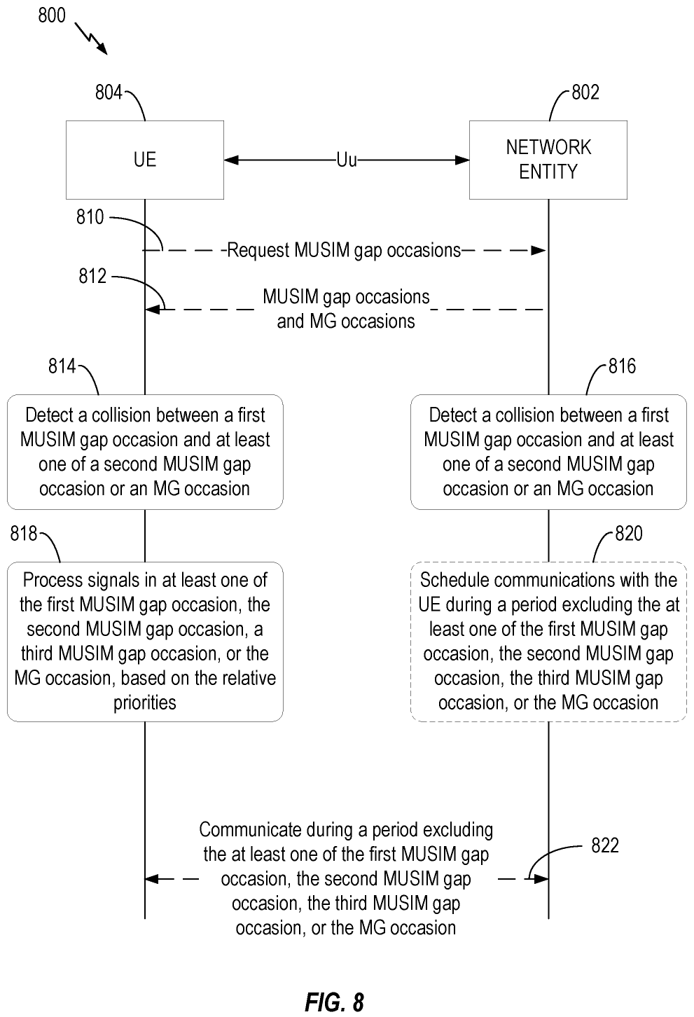

FIG. 8 depicts an example call flow 800 for communications in a network between a network entity 802 and a user equipment (UE) 804, according to aspects of the present disclosure. In some aspects, the network entity 802 may be an example of the BS 102 depicted and described with respect to FIGS. 1 and 3 or a disaggregated base station depicted and described with respect to FIG. 2. Similarly, the UE 804 may be an example of UE 104 depicted and described with respect to FIGS. 1 and 3. However, in other aspects, UE 104 may be another type of wireless communications device and BS 102 may be another type of network entity or network node, such as those described herein.

At 810, the UE optionally sends a request to the network entity to have the network configure MUSIM gap occasions (e.g., by transmitting a MUSIM gap configuration) for the UE.

At 812, the network entity optionally configures the UE with MUSIM gap occasions and MG occasions. The network entity may send to the UE up to three periodic MUSIM gap configurations, an aperiodic MUSIM gap configuration, and various MG configurations.

At 814, the UE detects a collision between a first MUSIM gap occasion and at least one of a second MUSIM gap occasion or a measurement gap (MG) occasion. As previously described, detecting a collision may include detecting that the first MUSIM gap occasion and the second MUSIM gap occasion or the MG occasion overlap in time or a separation in time between the first MUSIM gap occasion and the second MUSIM gap occasion or the MG occasion is less than or equal to a threshold period.

At 816, the network entity detects a collision between the first MUSIM gap occasion and at least one of the second MUSIM gap occasion or the MG occasion. While the detection by the network entity at 816 is depicted as being simultaneous with the detection by the UE at 814, the present disclosure is not so limited, and the network entity may detect the collision before or after the UE detects the collision. As with the UE, detecting the collision may include detecting that the first MUSIM gap occasion and the second MUSIM gap occasion or the MG occasion overlap in time or that a separation in time between the first MUSIM gap occasion and the second MUSIM gap occasion or the MG occasion is less than or equal to a threshold period.

At 818, the UE processes signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion. Processing signals may include one or more of transmitting signals, receiving signals, and measuring received signals (e.g., reference signals).

At 820, the network entity optionally schedules communications (e.g., transmissions and receptions) with the UE during a period excluding the at least one of the first MUSIM gap occasion, the second MUSIM gap occasion, the third MUSIM gap occasion, or the MG occasion.

At 822, the UE and the network entity optionally communicate during a period excluding the at least one of the first MUSIM gap occasion, the second MUSIM gap occasion, the third MUSIM gap occasion, or the MG occasion. The communications at 822 may be according to the scheduling performed by the network entity at 820.

According to aspects of the present disclosure, a network entity may assign priorities to MG occasions and MUSIM gap occasions for a UE. The priorities may be included in the MUSIM gap configuration(s) and MG configurations sent to the UE.

In aspects of the present disclosure, relative priorities of MUSIM gap occasions with respect to other MG occasions may be pre-defined (e.g., in a wireless communications standard), such that the relative priorities of the MUSIM gap occasions and the MG occasions are known to the UE and network entity.

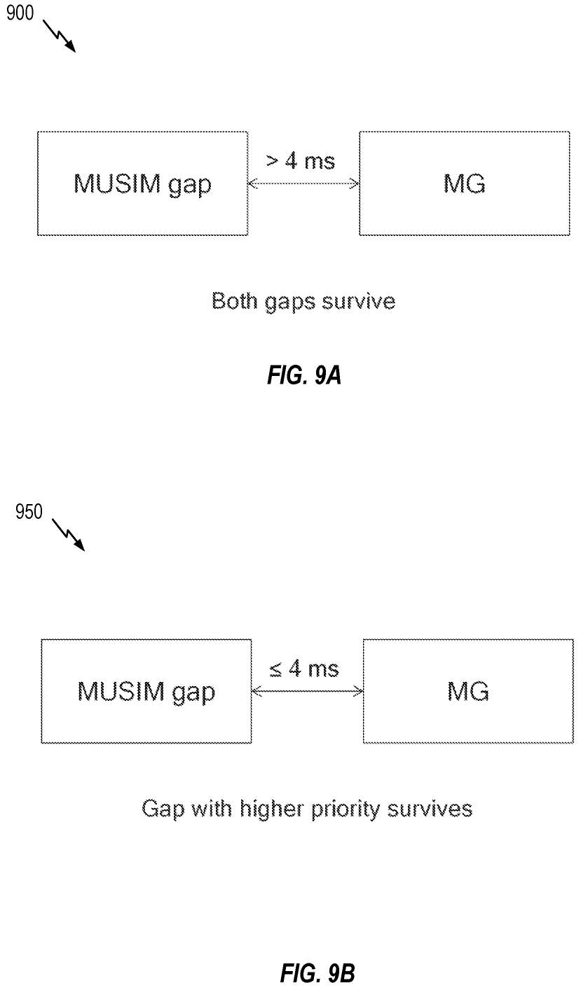

FIGS. 9A and 9B depict example timelines 900 and 950 of a MUSIM gap occasion and an MG occasion, in accordance with aspects of the present disclosure. In the example timelines, to determine whether the MUSIM gap occasion and the MG occasion collide, a separation in time between the MUSIM gap occasion and the MG occasion is compared a threshold period, e.g., four milliseconds, as illustrated. When, as depicted in the example timeline 900, the separation in time between the MUSIM gap occasion and the MG occasion is greater than the threshold period, then a device (e.g., the UE 804 or the network entity 802, depicted in FIG. 8) detects that the MUSIM gap occasion and the MG occasion do not collide, and both gap occasions survive, i.e., the UE tunes, measures, and/or communicates using both gap occasions.

When, as depicted in the example timeline 950, the separation in time between the MUSIM gap occasion and the MG occasion is less than or equal to the threshold period, then a device (e.g., the UE 804 or the network entity 802, depicted in FIG. 8) detects that the MUSIM gap occasion and the MG occasion collide, and only the gap occasion with the higher priority survives, i.e., the UE retunes to another frequency or network and then measures and/or communicates using the gap occasion having the higher priority. Measuring and/or communicating using the gap occasion having the higher priority is an example of the UE processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion, as illustrated at 816 in FIG. 8.

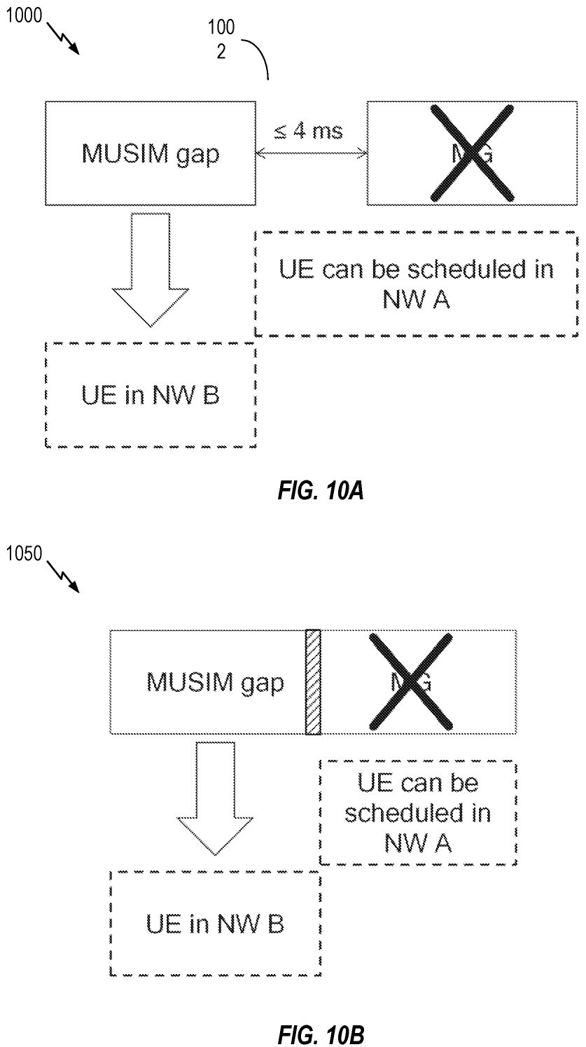

FIG. 10A depicts an example timeline 1000 of a MUSIM gap occasion and an MG occasion that collide, in accordance with aspects of the present disclosure. In the example timeline, the MUSIM gap occasion has a higher priority than the MG occasion. In the example timeline, the separation in time between the MUSIM gap occasion and the MG occasion is less than or equal to the threshold period, and a device (e.g., the UE 804 or the network entity 802, depicted in FIG. 8) detects that the MUSIM gap occasion and the MG occasion collide. The device drops the MG occasion because the MG occasion has lower priority. Then, as illustrated, the UE transmits or receives signals in network B during the MUSIM gap occasion and can be scheduled to transmit or receive signals in network A during the MG occasion and the period between the MUSIM gap occasion and the MG occasion. Measuring and/or communicating in network B during the MUSIM gap occasion is an example of the UE processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion, as illustrated at 816 in FIG. 8. The UE transmitting or receiving signals in network A during the MG occasion and the period between the MUSIM gap occasion and the MG occasion is an example of the UE communicating during a period excluding the at least one of the first MUSIM gap occasion, the second MUSIM gap occasion, the third MUSIM gap occasion, or the MG occasion, as illustrated at 820 in FIG. 8.

FIG. 10B depicts an example timeline 1050 of a MUSIM gap occasion and an MG occasion that collide, in accordance with aspects of the present disclosure. In the example timeline, the MUSIM gap occasion has a higher priority than the MG occasion. In the example timeline 1050, the MUSIM gap occasion and the MG occasion overlap in time (as shown by the cross-hatched area), and a device (e.g., the UE 804 or the network entity 802, depicted in FIG. 8) detects that the MUSIM gap occasion and the MG occasion collide. The device drops the MG occasion because the MG occasion has lower priority. Then, as illustrated, the UE transmits or receives signals in network B during the MUSIM gap occasion and can be scheduled to transmit or receive signals in network A during the portion of the MG occasion that does not overlap in time with the MUSIM gap occasion. Measuring and/or communicating in network B during the MUSIM gap occasion is an example of the UE processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion, as illustrated at 816 in FIG. 8. The UE transmitting or receiving signals in network A during the portion of the MG occasion that does not overlap in time with the MUSIM gap occasion is an example of the UE communicating during a period excluding the at least one of the first MUSIM gap occasion, the second MUSIM gap occasion, the third MUSIM gap occasion, or the MG occasion, as illustrated at 820 in FIG. 8.

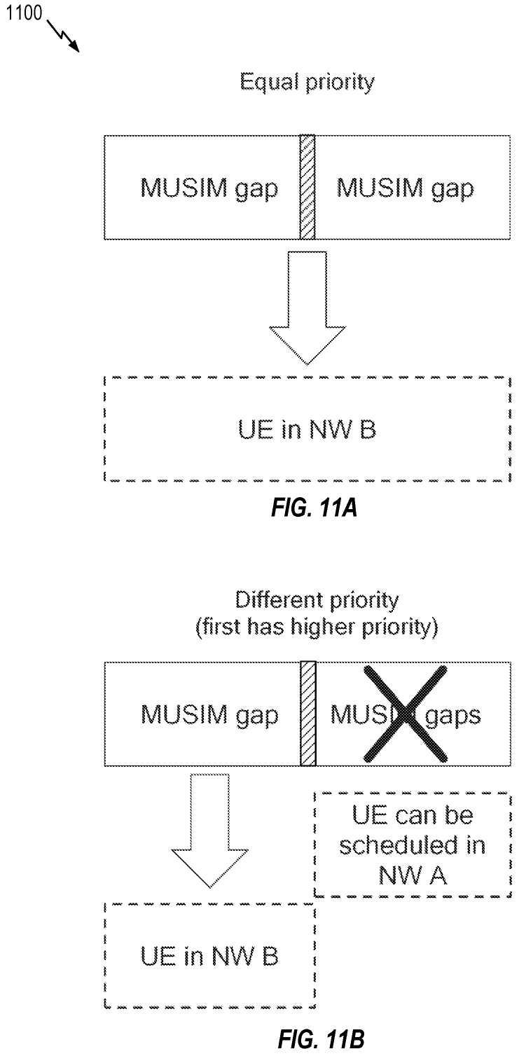

FIG. 11A depicts an example timeline 1100 of two MUSIM gap occasions that overlap in time, in accordance with aspects of the present disclosure. In the example timeline, the two MUSIM gap occasions have the same priority. In the example timeline, the separation in time between the two MUSIM gap occasions is less than or equal to the threshold period, and a device (e.g., the UE 804 or the network entity 802, depicted in FIG. 8) detects that the two MUSIM gap occasions collide. The device may merge the two MUSIM gap occasions because the MUSIM gap occasions have the same priority. Then, as illustrated, the UE transmits or receives signals in network B during the merged MUSIM gap occasion. Measuring and/or communicating in network B during the merged MUSIM gap occasions is an example of the UE processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion, as illustrated at 816 in FIG. 8.

FIG. 11B depicts an example timeline 1150 of two MUSIM gap occasions that overlap in time, in accordance with aspects of the present disclosure. In the example timeline, the earlier MUSIM gap occasion has a higher priority than the later MUSIM gap occasion. In the example timeline, the separation in time between the two MUSIM gap occasions is less than or equal to the threshold period, and a device (e.g., the UE 804 or the network entity 802, depicted in FIG. 8) detects that the two MUSIM gap occasions collide. The device drops the later MUSIM gap occasion because the later MUSIM gap occasion has lower priority. Then, as illustrated, the UE transmits or receives signals in network B during the higher-priority MUSIM gap occasion and can be scheduled to transmit or receive signals in network A during the portion of the lower-priority MUSIM gap occasion that does not overlap in time with the higher-priority MUSIM gap occasion. Measuring and/or communicating in network B during the higher-priority MUSIM gap occasion is an example of the UE processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion, as illustrated at 816 in FIG. 8. The UE transmitting or receiving signals in network A during the portion of the lower-priority MUSIM gap occasion that does not overlap in time with the higher-priority MUSIM gap occasion is an example of the UE communicating during a period excluding the at least one of the first MUSIM gap occasion, the second MUSIM gap occasion, the third MUSIM gap occasion, or the MG occasion, as illustrated at 820 in FIG. 8.

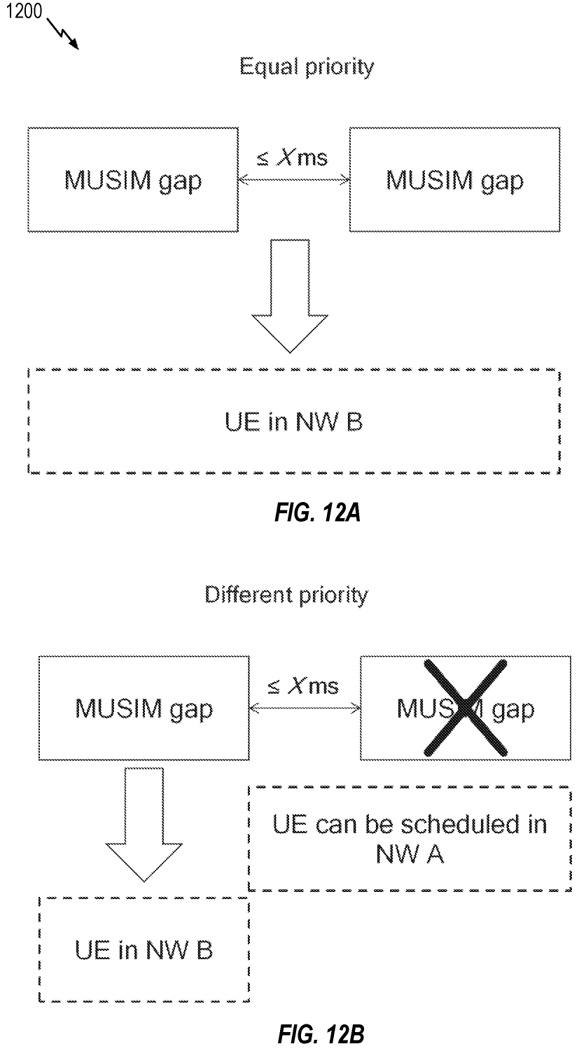

FIG. 12A depicts an example timeline 1200 of two MUSIM gap occasions that collide without overlapping in time, in accordance with aspects of the present disclosure. In the example timeline, the two MUSIM gap occasions have the same priority. In the example timeline, the separation in time between the two MUSIM gap occasions is less than or equal to the threshold period (X ms), and a device (e.g., the UE 804 or the network entity 802, depicted in FIG. 8) detects that the two MUSIM gap occasions collide. The device may merge the two MUSIM gap occasions because the MUSIM gap occasions have the same priority. Then, as illustrated, the UE transmits or receives signals in network B during the merged MUSIM gap occasions. Measuring and/or communicating in network B during the merged MUSIM gap occasions is an example of the UE processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion, as illustrated at 816 in FIG. 8.

FIG. 12B depicts an example timeline 1250 of two MUSIM gap occasions that collide without overlapping in time, in accordance with aspects of the present disclosure. In the example timeline, the earlier MUSIM gap occasion has a higher priority than the later MUSIM gap occasion. In the example timeline, the separation in time between the two MUSIM gap occasions is less than or equal to the threshold period (X ms), and a device (e.g., the UE 804 or the network entity 802, depicted in FIG. 8) detects that the two MUSIM gap occasions collide. The device drops the later MUSIM gap occasion because the later MUSIM gap occasion has lower priority. Then, as illustrated, the UE transmits or receives signals in network B during the higher-priority MUSIM gap occasion and can be scheduled to transmit or receive signals in network A during the lower-priority MUSIM gap occasion and the separation in time between the lower-priority MUSIM gap occasion and the higher-priority MUSIM gap occasion. Measuring and/or communicating in network B during the higher-priority MUSIM gap occasion is an example of the UE processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion, as illustrated at 816 in FIG. 8. The UE transmitting or receiving signals in network A during the lower-priority MUSIM gap occasion and the separation in time between the lower-priority MUSIM gap occasion and the higher-priority MUSIM gap occasion is an example of the UE communicating during a period excluding the at least one of the first MUSIM gap occasion, the second MUSIM gap occasion, the third MUSIM gap occasion, or the MG occasion, as illustrated at 820 in FIG. 8.

In aspects of the present disclosure, a device (e.g., a UE or a network entity) may resolve collisions between multiple MUSIM gap occasions in order of decreasing order of the MUSIM gap occasions. That is, a device may resolve collisions between MUSIM gap occasions having the highest priority and lower-priority MUSIM gap occasions, and then, after possibly dropping some of the lower-priority MUSIM gap occasions, the device resolves collisions between MUSIM gap occasions having a next-highest priority and lower-priority MUSIM gap occasions. The device continues with the resolution of the collisions until all collisions have been resolved. It may be noted that in such an occurrence, a lower-priority MUSIM gap occasion colliding with a higher-priority MUSIM gap occasion may survive, if the higher-priority MUSIM gap occasion is dropped because the higher-priority MUSIM gap occasion collides with a still-higher-priority MUSIM gap occasion.

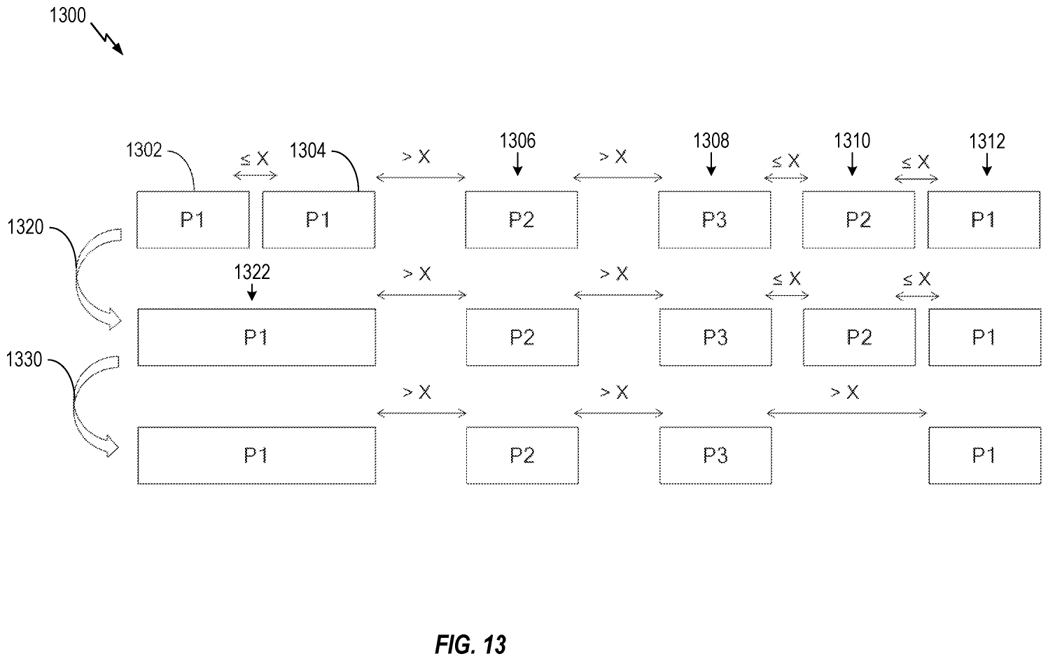

FIG. 13 is a block diagram 1300 of an example process of resolving collisions of MUSIM gap occasions, in accordance with aspects of the present disclosure. Each of the MUSIM gap occasions has a priority of “P1,” “P2,” or “P3,” as illustrated. In the depicted process, P1 is a higher priority than P2, which is a higher priority than P3. In the depicted process, the threshold period for determining if two MUSIM gap occasions collide is “X.” The process begins with a network device configured with MUSIM gap occasions 1302, 1304, 1306, 1308, 1310, and 1312. As illustrated, MUSIM gap occasions 1302 and 1304 are separated in time by a period that is less than or equal to X. MUSIM gap occasions 1304 and 1306 are separated in time by a period that is greater than X. MUSIM gap occasions 1306 and 1308 are also separated in time by a period that is greater than X. MUSIM gap occasions 1308 and 1310 are separated in time by a period that is less than or equal to X. Finally, MUSIM gap occasions 1310 and 1312 are separated in time by a period that is less than or equal to X.

In the step 1320 of the depicted process, the network device resolves conflicts among all MUSIM gap occasions having the highest priority, P1. As illustrated, MUSIM gap occasions 1302 and 1304 are separated in time by less than X, so the device detects that MUSIM gap occasions 1302 and 1304 collide. The device resolves the conflict between MUSIM gap occasions 1302 and 1304 by merging those MUSIM gap occasions to form MUSIM gap occasion 1322, which has the same priority, P1, as the merged MUSIM gap occasions 1302 and 1304.

In the step 1330 of the depicted process, the network device resolves conflicts among MUSIM gap occasions having the highest priority and MUSIM gap occasions having lower priority. As illustrated, MUSIM gap occasions 1310 and 1312 are separated in time by less than X, so the device determines that MUSIM gap occasions 1310 and 1312 collide. The device resolves the conflict between MUSIM gap occasions 1310 and 1312 by dropping the lower-priority MUSIM gap occasion, which is MUSIM gap occasion 1310.

After completion of step 1330, the device does not detect that any of the MUSIM gap occasions 1322, 1306, 1308, and 1312 collide, as each of the MUSIM gap occasions is separated in time by more than X from all of the other MUSIM gap occasions. It may be noted that MUSIM gap occasion 1308 survives the process of resolving conflicts, despite MUSIM gap occasion 1308 appearing to conflict with the higher-priority MUSIM gap occasion 1310.

According to aspects of the present disclosure, a UE may request (e.g., from a network entity) the priority for each MUSIM gap occasion configured at the UE. The UE may, for example, request the priorities for the MUSIM gap occasions by sending a request for UE assistance information (UAI) to the network (e.g., to a network entity, such as a base station).

### Example Operations of a User Equipment

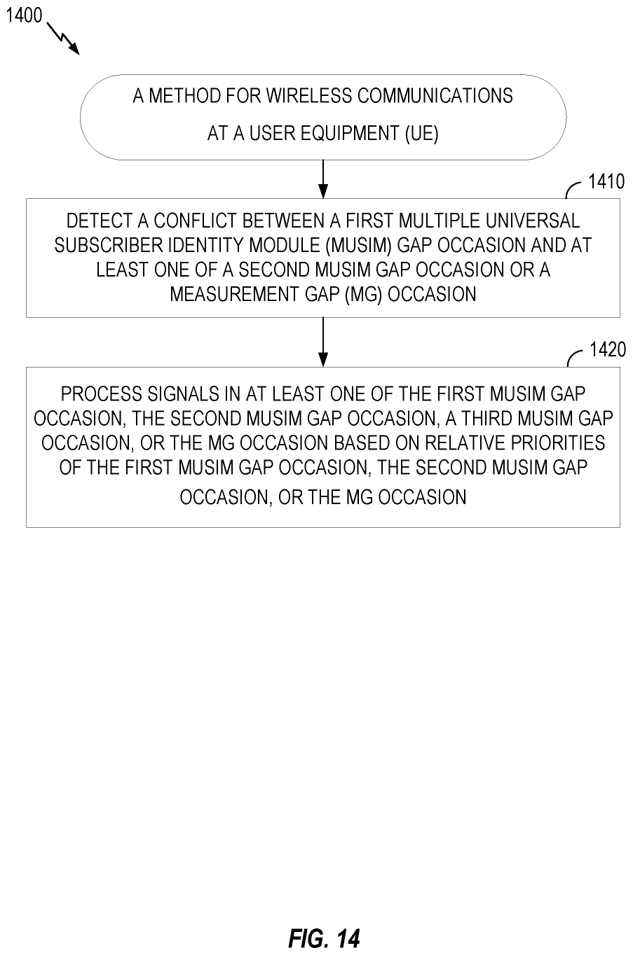

FIG. 14 shows a method 1400 for wireless communications by a UE, such as UE 104 of FIGS. 1 and 3.

Method 1400 begins at 1410 with detecting a collision between a first multiple universal subscriber identity module (MUSIM) gap occasion and at least one of a second MUSIM gap occasion or a measurement gap (MG) occasion.

Method 1400 then proceeds to step 1420 with processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion.

In one aspect, detecting the collision comprises detecting that a separation in time between the first MUSIM gap occasion and the MG occasion is less than or equal to a threshold period.

In one aspect, the threshold period is four milliseconds.

In one aspect, the first MUSIM gap occasion conflicts with the MG occasion; processing the signals comprises receiving or transmitting signals via a second network during the first MUSIM gap occasion; and method 1400 further includes communicating via a first network during a period excluding the first MUSIM gap occasion.

In one aspect, method 1400 further includes communicating via the first network during at least a portion of the MG occasion.

In one aspect, the first MUSIM gap occasion collides with the MG occasion; processing the signals comprises measuring a signal on a network during the MG occasion; and method 1400 further includes communicating via the network during a period excluding the MG occasion.

In one aspect, method 1400 further includes communicating via the network during at least a portion of the MUSIM gap occasion.

In one aspect, the first MUSIM gap occasion collides with the second MUSIM gap occasion; processing the signals comprises receiving or transmitting signals via a second network during the third MUSIM gap occasion; and method 1400 further includes receiving or transmitting signals via a first network during a period excluding the third MUSIM gap occasion.

In one aspect, the relative priority of the first MUSIM gap occasion is the same as the relative priority of the second MUSIM gap occasion, and method 1400 further includes determining the third MUSIM gap occasion as a union of the first MUSIM gap occasion and the second MUSIM gap occasion.

In one aspect, detecting the collision comprises detecting that a separation in time between the first MUSIM gap occasion and the second MUSIM gap occasion is less than or equal to a threshold period.

In one aspect, the relative priority of the first MUSIM gap occasion equals the relative priority of the second MUSIM gap occasion, and method 1400 further includes determining the third MUSIM gap occasion as the union of the first MUSIM gap occasion, the second MUSIM gap occasion, and the separation in time.

In one aspect, the first MUSIM gap occasion collides with the second MUSIM gap occasion; the relative priority of the first MUSIM gap occasion is greater than the relative priority of the second MUSIM gap occasion; and processing the signals comprises receiving or transmitting signals via a second network during the first MUSIM gap occasion; and method 1400 further includes communicating via a first network during a period excluding the first MUSIM gap occasion.

In one aspect, method 1400 further includes communicating via the first network during at least a portion of the second MUSIM gap occasion.

In one aspect, detecting the collision comprises detecting a separation in time between the first MUSIM gap occasion and the second MUSIM gap occasion is less than or equal to a threshold period.

In one aspect, the first MUSIM gap occasion collides with the second MUSIM gap occasion; the second MUSIM gap occasion collides with a fourth MUSIM gap occasion; the first MUSIM gap occasion has a higher relative priority than the second MUSIM gap occasion, which has a higher relative priority than the fourth MUSIM gap occasion; and method 1400 further includes dropping the second MUSIM gap occasion; transmitting or receiving signals via a first network during a period excluding the first MUSIM gap occasion and the fourth MUSIM gap occasion; and transmitting or receiving signals via a second network during the first MUSIM gap occasion and during the fourth MUSIM gap occasion.

In one aspect, method 1400 further includes transmitting a request for the relative priorities of the first MUSIM gap occasion and the second MUSIM gap occasion.

In one aspect, transmitting the request comprises transmitting a request for UE Assistance Information (UAI).

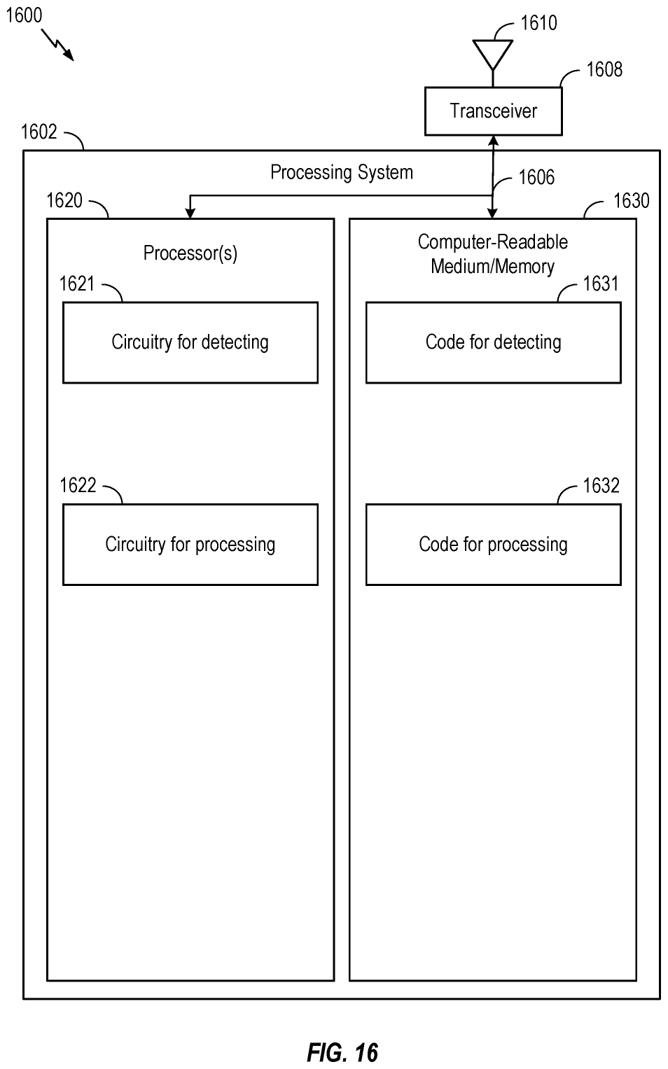

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

### Example Operations of a Network Entity

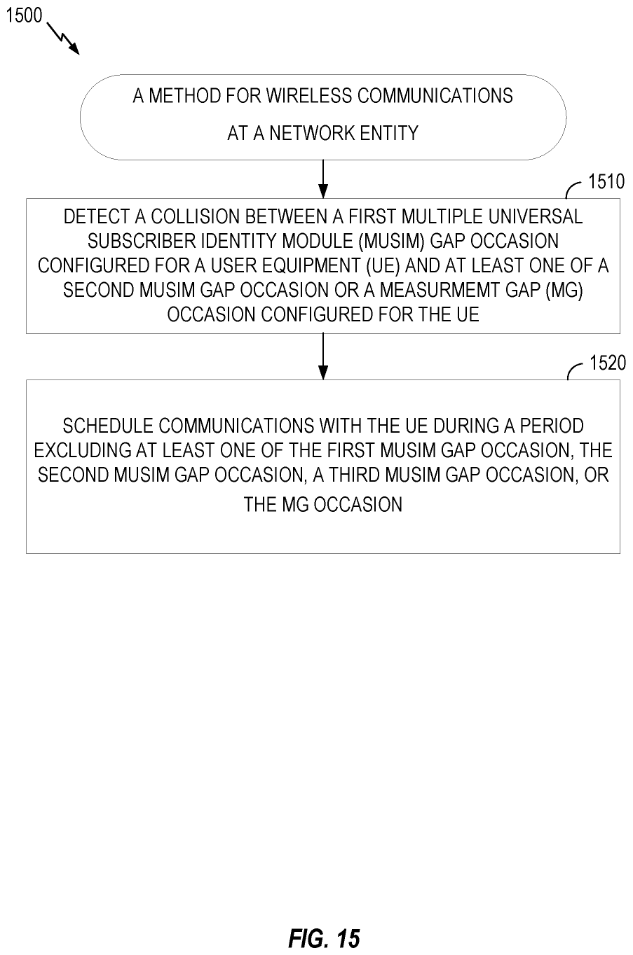

FIG. 15 shows a method 1500 for wireless communications by a network entity, such as BS 102 of FIGS. 1 and 3, or a disaggregated base station as discussed with respect to FIG. 2.

Method 1500 begins at 1510 with detecting a collision between a first multiple universal subscriber identity module (MUSIM) gap occasion configured for a user equipment (UE) and at least one of a second MUSIM gap occasion or a measurement gap (MG) occasion configured for the UE.

Method 1500 then proceeds to step 1520 with scheduling communications with the UE during a period excluding at least one of the first MUSIM gap occasion, the second MUSIM gap occasion, a third MUSIM gap occasion, or the MG occasion.

In one aspect, detecting the collision comprises detecting that a separation in time between the first MUSIM gap occasion and the MG occasion is less than or equal to a threshold period.

In one aspect, the threshold period is four milliseconds.

In one aspect, the first MUSIM gap occasion collides with the MG occasion; the period excludes the first MUSIM gap occasion; and method 1500 further includes communicating with the UE during the period.

In one aspect, method 1500 further includes communicating with the UE during at least a portion of the MG occasion.

In one aspect, the first MUSIM gap occasion collides with the MG occasion; the period excludes the MG occasion; and method 1500 further includes communicating with the UE during the period.

In one aspect, method 1500 further includes communicating with the UE during at least a portion of the first MUSIM gap occasion.

In one aspect, the first MUSIM gap occasion collides with the second MUSIM gap occasion; the period excludes the third MUSIM gap occasion; and method 1500 further includes communicating with the UE during the period.

In one aspect, the relative priority of the first MUSIM gap occasion is the same as the relative priority of the second MUSIM gap occasion, and method 1500 further includes determining the third MUSIM gap occasion as a union of the first MUSIM gap occasion and the second MUSIM gap occasion.

In one aspect, detecting the collision comprises detecting that a separation in time between the first MUSIM gap occasion and the second MUSIM gap occasion is less than or equal to a threshold period.

In one aspect, the relative priority of the first MUSIM gap occasion equals the relative priority of the second MUSIM gap occasion, and determining the third MUSIM gap occasion as a union of the first MUSIM gap occasion, the second MUSIM gap occasion, and the separation in time.

In one aspect, the first MUSIM gap occasion collides with the second MUSIM gap occasion; the relative priority of the first MUSIM gap occasion is greater than the relative priority of the second MUSIM gap occasion; and the period excludes the first MUSIM gap occasion; and method 1500 further includes communicating with the UE during the period.

In one aspect, method 1500 further includes communicating with the UE during at least a portion of the second MUSIM gap occasion.

In one aspect, detecting the collision comprises detecting a separation in time between the first MUSIM gap occasion and the second MUSIM gap occasion is less than or equal to a threshold period.

In one aspect, the first MUSIM gap occasion collides with the second MUSIM gap occasion; the second MUSIM gap occasion collides with a fourth MUSIM gap occasion; the first MUSIM gap occasion has a higher relative priority than the second MUSIM gap occasion, which has a higher relative priority than the fourth MUSIM gap occasion; and method 1500 further includes communicating with the UE during a period excluding the first MUSIM gap occasion and the fourth MUSIM gap occasion.

In one aspect, method 1500 further includes receiving a request for the relative priorities of the first MUSIM gap occasion and the second MUSIM gap occasion.

In one aspect, the request comprises a request for UE Assistance Information (UAI).

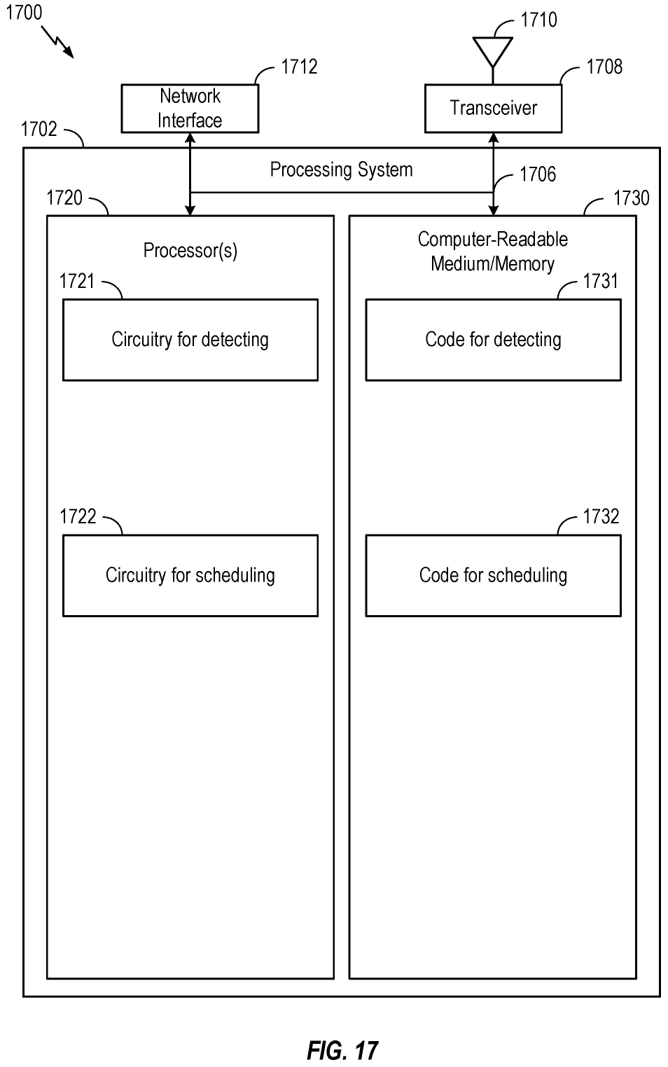

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

### Example Communications Devices

FIG. 16 depicts aspects of an example communications device 1600. In some aspects, communications device 1600 is a user equipment, such as UE 104 described above with respect to FIGS. 1 and 3.

The communications device 1600 includes a processing system 1602 coupled to a transceiver 1608 (e.g., a transmitter and/or a receiver). The transceiver 1608 is configured to transmit and receive signals for the communications device 1600 via an antenna 1610, such as the various signals as described herein. The processing system 1602 may be configured to perform processing functions for the communications device 1600, including processing signals received and/or to be transmitted by the communications device 1600.

The processing system 1602 includes one or more processors 1620. In various aspects, the one or more processors 1620 may be representative of one or more of receive processor 358, transmit processor 364, TX MIMO processor 366, and/or controller/processor 380, as described with respect to FIG. 3. The one or more processors 1620 are coupled to a computer-readable medium/memory 1630 via a bus 1606. In certain aspects, the computer-readable medium/memory 1630 is configured to store instructions (e.g., computer-executable code) that when executed by the one or more processors 1620, cause the one or more processors 1620 to perform the method 1400 described with respect to FIG. 14, or any aspect related to it. Note that reference to a processor performing a function of communications device 1600 may include one or more processors performing that function of communications device 1600.

In the depicted example, computer-readable medium/memory 1630 stores code (e.g., executable instructions) for detecting 1631 and, code for processing 1632. Processing of the code 1631-1632 may cause the communications device 1600 to perform the method 1400 described with respect to FIG. 14, or any aspect related to it.

The one or more processors 1620 include circuitry configured to implement (e.g., execute) the code stored in the computer-readable medium/memory 1630, including circuitry for detecting 1621 and circuitry for processing 1622. Processing with circuitry 1621-1622 may cause the communications device 1600 to perform the method 1400 described with respect to FIG. 14, or any aspect related to it.

Various components of the communications device 1600 may provide means for performing the method 1400 described with respect to FIG. 14, or any aspect related to it. For example, means for transmitting, sending, processing, or outputting for transmission may include the transceivers 354 and/or antenna(s) 352 of the UE 104 illustrated in FIG. 3 and/or transceiver 1608 and antenna 1610 of the communications device 1600 in FIG. 16. Means for receiving, processing, or obtaining may include the transceivers 354 and/or antenna(s) 352 of the UE 104 illustrated in FIG. 3 and/or transceiver 1608 and antenna 1610 of the communications device 1600 in FIG. 16. Means for detecting or processing may include the transmit processor 364, controller/processor 380, receive processor 358 of the UE 104 illustrated in FIG. 3 and/or processors 1620 and computer-readable medium/memory 1630 of the communications device 1600 in FIG. 16.

FIG. 17 depicts aspects of an example communications device. In some aspects, communications device 1700 is a network entity, such as BS 102 of FIGS. 1 and 3, or a disaggregated base station as discussed with respect to FIG. 2.

The communications device 1700 includes a processing system 1702 coupled to a transceiver 1708 (e.g., a transmitter and/or a receiver) and/or a network interface 1712. The transceiver 1708 is configured to transmit and receive signals for the communications device 1700 via an antenna 1710, such as the various signals as described herein. The network interface 1712 is configured to obtain and send signals for the communications device 1700 via communications link(s), such as a backhaul link, midhaul link, and/or fronthaul link as described herein, such as with respect to FIG. 2. The processing system 1702 may be configured to perform processing functions for the communications device 1700, including processing signals received and/or to be transmitted by the communications device 1700.

The processing system 1702 includes one or more processors 1720. In various aspects, one or more processors 1720 may be representative of one or more of receive processor 338, transmit processor 320, TX MIMO processor 330, and/or controller/processor 340, as described with respect to FIG. 3. The one or more processors 1720 are coupled to a computer-readable medium/memory 1730 via a bus 1706. In certain aspects, the computer-readable medium/memory 1730 is configured to store instructions (e.g., computer-executable code) that when executed by the one or more processors 1720, cause the one or more processors 1720 to perform the method 1500 described with respect to FIG. 15, or any aspect related to it. Note that reference to a processor of communications device 1700 performing a function may include one or more processors of communications device 1700 performing that function.

In the depicted example, the computer-readable medium/memory 1730 stores code (e.g., executable instructions) for detecting 1731 and code for scheduling 1732. Processing of the code 1731-1732 may cause the communications device 1700 to perform the method 1500 described with respect to FIG. 15, or any aspect related to it.

The one or more processors 1720 include circuitry configured to implement (e.g., execute) the code stored in the computer-readable medium/memory 1730, including circuitry for detecting 1721 and circuitry for scheduling 1722. Processing with circuitry 1721-1722 may cause the communications device 1700 to perform the method 1500 as described with respect to FIG. 15, or any aspect related to it.

Various components of the communications device 1700 may provide means for performing the method 1500 as described with respect to FIG. 15, or any aspect related to it. Means for transmitting, sending, scheduling, or outputting for transmission may include the transceivers 332 and/or antenna(s) 334 of the BS 102 illustrated in FIG. 3 and/or transceiver 1708 and antenna 1710 of the communications device 1700 in FIG. 17. Means for receiving or obtaining may include the transceivers 332 and/or antenna(s) 334 of the BS 102 illustrated in FIG. 3 and/or transceiver 1708 and antenna 1710 of the communications device 1700 in FIG. 17. Means for processing, detecting, or scheduling may include the transmit processor 320, controller/processor 340, and scheduler 344 of the BS 102 illustrated in FIG. 3 and/or transceiver 1708, antenna 1710, processor(s) 1720, and computer-readable medium/memory 1730 of the communications device 1700 in FIG. 17.

### Example Clauses

Implementation examples are described in the following numbered clauses:

Clause 1: A method for wireless communications at a user equipment (UE), comprising: detecting a collision between a first multiple universal subscriber identity module (MUSIM) gap occasion and at least one of a second MUSIM gap occasion or a measurement gap (MG) occasion; and processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion.

Clause 2: The method of claim 1, wherein detecting the collision comprises detecting that a separation in time between the first MUSIM gap occasion and the MG occasion is less than or equal to a threshold period.

Clause 3: The method of claim 2, wherein the threshold period is four milliseconds.

Clause 4: The method of any of claims 1-3, wherein: the first MUSIM gap occasion collides with the MG occasion; processing the signals comprises receiving or transmitting signals via a second network during the first MUSIM gap occasion; and the method further comprising: communicating via a first network during a period excluding the first MUSIM gap occasion.

Clause 5: The method of claim 4, further comprising: communicating via the first network during at least a portion of the MG occasion.

Clause 6: The method of any of claims 1-5, wherein: the first MUSIM gap occasion collides with the MG occasion; processing the signals comprises measuring a signal on a network during the MG occasion; and the method further comprising: communicating via the network during a period excluding the MG occasion.

Clause 7: The method of claim 6, further comprising: communicating via the network during at least a portion of the MUSIM gap occasion.

Clause 8: The method of any of claims 1-7, wherein: the first MUSIM gap occasion collides with the second MUSIM gap occasion; processing the signals comprises receiving or transmitting signals via a second network during the third MUSIM gap occasion; and the method further comprising: receiving or transmitting signals via a first network during a period excluding the third MUSIM gap occasion.

Clause 9: The method of claim 8, wherein the relative priority of the first MUSIM gap occasion is the same as the relative priority of the second MUSIM gap occasion, and the method further comprising: determining the third MUSIM gap occasion as a union of the first MUSIM gap occasion and the second MUSIM gap occasion.

Clause 10: The method of any of claims 8-9, wherein detecting the collision comprises detecting that a separation in time between the first MUSIM gap occasion and the second MUSIM gap occasion is less than or equal to a threshold period.

Clause 11: The method of claim 10, wherein the relative priority of the first MUSIM gap occasion equals the relative priority of the second MUSIM gap occasion, and the method further comprising: determining the third MUSIM gap occasion as a union of the first MUSIM gap occasion, the second MUSIM gap occasion, and the separation in time.

Clause 12: The method of any of claims 1-11, wherein: the first MUSIM gap occasion collides with the second MUSIM gap occasion; the relative priority of the first MUSIM gap occasion is greater than the relative priority of the second MUSIM gap occasion; and processing the signals comprises receiving or transmitting signals via a second network during the first MUSIM gap occasion; and the method further comprising: communicating via a first network during a period excluding the first MUSIM gap occasion.

Clause 13: The method of claim 12, further comprising: communicating via the first network during at least a portion of the second MUSIM gap occasion.

Clause 14: The method of any of claims 12-13, wherein detecting the collision comprises detecting a separation in time between the first MUSIM gap occasion and the second MUSIM gap occasion is less than or equal to a threshold period.

Clause 15: The method of any of claims 1-14, wherein: the first MUSIM gap occasion collides with the second MUSIM gap occasion; the second MUSIM gap occasion collides with a fourth MUSIM gap occasion; the first MUSIM gap occasion has a higher relative priority than the second MUSIM gap occasion, which has a higher relative priority than the fourth MUSIM gap occasion; and the method further comprises: dropping the second MUSIM gap occasion; transmitting or receiving signals via a first network during a period excluding the first MUSIM gap occasion and the fourth MUSIM gap occasion; and transmitting or receiving signals via a second network during the first MUSIM gap occasion and during the fourth MUSIM gap occasion.

Clause 16: The method of any of claims 1-15, further comprising: transmitting a request for the relative priorities of the first MUSIM gap occasion and the second MUSIM gap occasion.

Clause 17: The method of claim 16, wherein transmitting the request comprises transmitting a request for UE Assistance Information (UAI).

Clause 18: A method for wireless communications at a network entity, comprising: detecting a collision between a first multiple universal subscriber identity module (MUSIM) gap occasion configured for a user equipment (UE) and at least one of a second MUSIM gap occasion or a measurement gap (MG) occasion configured for the UE; and scheduling communications with the UE during a period excluding at least one of the first MUSIM gap occasion, the second MUSIM gap occasion, a third MUSIM gap occasion, or the MG occasion.

Clause 19: The method of claim 18, wherein detecting the collision comprises detecting that a separation in time between the first MUSIM gap occasion and the MG occasion is less than or equal to a threshold period.

Clause 20: The method of claim 19, wherein the threshold period is four milliseconds.

Clause 21: The method of any of claims 18-20, wherein: the first MUSIM gap occasion collides with the MG occasion; the period excludes the first MUSIM gap occasion; and the method further comprising: communicating with the UE during the period.

Clause 22: The method of claim 21, further comprising: communicating with the UE during at least a portion of the MG occasion.

Clause 23: The method of any of claims 18-22, wherein: the first MUSIM gap occasion collides with the MG occasion; the period excludes the MG occasion; and the method further comprising: communicating with the UE during the period.

Clause 24: The method of claim 23, further comprising: communicating with the UE during at least a portion of the first MUSIM gap occasion.

Clause 25: The method of any of claims 18-24, wherein: the first MUSIM gap occasion collides with the second MUSIM gap occasion; the period excludes the third MUSIM gap occasion; and the method further comprising: communicating with the UE during the period.

Clause 26: The method of claim 25, wherein the relative priority of the first MUSIM gap occasion is the same as the relative priority of the second MUSIM gap occasion, and the method further comprising: determining the third MUSIM gap occasion as a union of the first MUSIM gap occasion and the second MUSIM gap occasion.

Clause 27: The method of any of claims 25-26, wherein detecting the collision comprises detecting that a separation in time between the first MUSIM gap occasion and the second MUSIM gap occasion is less than or equal to a threshold period.

Clause 28: The method of claim 27, wherein the relative priority of the first MUSIM gap occasion equals the relative priority of the second MUSIM gap occasion, and the method further comprising: determining the third MUSIM gap occasion as the union of the first MUSIM gap occasion, the second MUSIM gap occasion, and the separation in time.

Clause 29: The method of any of claims 18-28, wherein: the first MUSIM gap occasion collides with the second MUSIM gap occasion; the relative priority of the first MUSIM gap occasion is greater than the relative priority of the second MUSIM gap occasion; and the period excludes the first MUSIM gap occasion; and the method further comprising: communicating with the UE during the period.

Clause 30: The method of claim 29, further comprising: communicating with the UE during at least a portion of the second MUSIM gap occasion.

Clause 31: The method of any of claims 29-30, wherein detecting the collision comprises detecting a separation in time between the first MUSIM gap occasion and the second MUSIM gap occasion is less than or equal to a threshold period.

Clause 32: The method of any of claims 18-31, wherein: the first MUSIM gap occasion collides with the second MUSIM gap occasion; the second MUSIM gap occasion collides with a fourth MUSIM gap occasion; the first MUSIM gap occasion has a higher relative priority than the second MUSIM gap occasion, which has a higher relative priority than the fourth MUSIM gap occasion; and the method further comprises: communicating with the UE during a period excluding the first MUSIM gap occasion and the fourth MUSIM gap occasion.

Clause 33: The method of any of claims 18-32, further comprising: receiving a request for the relative priorities of the first MUSIM gap occasion and the second MUSIM gap occasion.

Clause 34: The method of claim 33, wherein the request comprises a request for UE Assistance Information (UAI).

Clause 35: An apparatus, comprising: a memory comprising executable instructions; and a processor configured to execute the executable instructions and cause the apparatus to perform a method in accordance with any one of Clauses 1-34.

Clause 36: An apparatus, comprising means for performing a method in accordance with any one of Clauses 1-34.

Clause 37: A non-transitory computer-readable medium comprising executable instructions that, when executed by a processor of an apparatus, cause the apparatus to perform a method in accordance with any one of Clauses 1-34.

Clause 38: A computer program product embodied on a computer-readable storage medium comprising code for performing a method in accordance with any one of Clauses 1-34.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications at a user equipment (UE), comprising:
detecting a collision between a first multiple universal subscriber identity module (MUSIM) gap occasion and at least one of a second MUSIM gap occasion or a measurement gap (MG) occasion; and
processing signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion.

2. The method of claim 1, wherein detecting the collision comprises detecting that a separation in time between the first MUSIM gap occasion and the MG occasion is less than or equal to a threshold period.

3. The method of claim 2, wherein the threshold period is four milliseconds.

4. The method of claim 1, wherein:
the first MUSIM gap occasion collides with the MG occasion;
processing the signals comprises receiving or transmitting signals via a second network during the first MUSIM gap occasion; and
the method further comprising:
communicating via a first network during a period excluding the first MUSIM gap occasion.

5. The method of claim 4, further comprising:
communicating via the first network during at least a portion of the MG occasion.

6. The method of claim 1, wherein:
the first MUSIM gap occasion collides with the MG occasion;
processing the signals comprises measuring a signal on a network during the MG occasion; and
the method further comprising:
communicating via the network during a period excluding the MG occasion.

7. The method of claim 6, further comprising:
communicating via the network during at least a portion of the MUSIM gap occasion.

8. The method of claim 1, wherein:
the first MUSIM gap occasion collides with the second MUSIM gap occasion;
processing the signals comprises receiving or transmitting signals via a second network during the third MUSIM gap occasion; and
the method further comprising:
receiving or transmitting signals via a first network during a period excluding the third MUSIM gap occasion.

9. The method of claim 8, wherein the relative priority of the first MUSIM gap occasion is the same as the relative priority of the second MUSIM gap occasion, and the method further comprising:
determining the third MUSIM gap occasion as a union of the first MUSIM gap occasion and the second MUSIM gap occasion.

10. The method of claim 8, wherein detecting the collision comprises detecting that a separation in time between the first MUSIM gap occasion and the second MUSIM gap occasion is less than or equal to a threshold period.

11. The method of claim 10, wherein the relative priority of the first MUSIM gap occasion equals the relative priority of the second MUSIM gap occasion, and the method further comprising:
determining the third MUSIM gap occasion as a union of the first MUSIM gap occasion, the second MUSIM gap occasion, and the separation in time.

12. The method of claim 1, wherein:
the first MUSIM gap occasion collides with the second MUSIM gap occasion;
the relative priority of the first MUSIM gap occasion is greater than the relative priority of the second MUSIM gap occasion; and
processing the signals comprises receiving or transmitting signals via a second network during the first MUSIM gap occasion; and
the method further comprising:
communicating via a first network during a period excluding the first MUSIM gap occasion.

13. The method of claim 12, further comprising:
communicating via the first network during at least a portion of the second MUSIM gap occasion.

14. The method of claim 12, wherein detecting the collision comprises detecting a separation in time between the first MUSIM gap occasion and the second MUSIM gap occasion is less than or equal to a threshold period.

15. The method of claim 1, wherein:
the first MUSIM gap occasion collides with the second MUSIM gap occasion;
the second MUSIM gap occasion collides with a fourth MUSIM gap occasion;
the first MUSIM gap occasion has a higher relative priority than the second MUSIM gap occasion, which has a higher relative priority than the fourth MUSIM gap occasion; and
the method further comprises:
dropping the second MUSIM gap occasion;
transmitting or receiving signals via a first network during a period excluding the first MUSIM gap occasion and the fourth MUSIM gap occasion; and
transmitting or receiving signals via a second network during the first MUSIM gap occasion and during the fourth MUSIM gap occasion.

16. The method of claim 1, further comprising:
transmitting a request for the relative priorities of the first MUSIM gap occasion and the second MUSIM gap occasion.

17. The method of claim 16, wherein transmitting the request comprises transmitting a request for UE Assistance Information (UAI).

18. A method for wireless communications at a network entity, comprising:
detecting a collision between a first multiple universal subscriber identity module (MUSIM) gap occasion configured for a user equipment (UE) and at least one of a second MUSIM gap occasion or a measurement gap (MG) occasion configured for the UE; and
scheduling communications with the UE during a period excluding at least one of the first MUSIM gap occasion, the second MUSIM gap occasion, a third MUSIM gap occasion, or the MG occasion.

19. The method of claim 18, wherein detecting the collision comprises detecting that a separation in time between the first MUSIM gap occasion and the MG occasion is less than or equal to a threshold period.

20. The method of claim 18, wherein:
the first MUSIM gap occasion collides with the MG occasion;
the period excludes the first MUSIM gap occasion; and
the method further comprising:
communicating with the UE during the period.

21. The method of claim 20, further comprising:
communicating with the UE during at least a portion of the MG occasion.

22. The method of claim 18, wherein:
the first MUSIM gap occasion collides with the MG occasion;
the period excludes the MG occasion; and
the method further comprising:
communicating with the UE during the period.

23. The method of claim 18, wherein:
the first MUSIM gap occasion collides with the second MUSIM gap occasion;
the period excludes the third MUSIM gap occasion; and
the method further comprising:
communicating with the UE during the period.

24. The method of claim 23, wherein the relative priority of the first MUSIM gap occasion is the same as the relative priority of the second MUSIM gap occasion, and the method further comprising:
determining the third MUSIM gap occasion as a union of the first MUSIM gap occasion and the second MUSIM gap occasion.

25. The method of claim 23, wherein detecting the collision comprises detecting that a separation in time between the first MUSIM gap occasion and the second MUSIM gap occasion is less than or equal to a threshold period.

26. The method of claim 18, wherein:
the first MUSIM gap occasion collides with the second MUSIM gap occasion;
the relative priority of the first MUSIM gap occasion is greater than the relative priority of the second MUSIM gap occasion; and
the period excludes the first MUSIM gap occasion; and
the method further comprising:
communicating with the UE during the period.

27. The method of claim 26, wherein detecting the collision comprises detecting a separation in time between the first MUSIM gap occasion and the second MUSIM gap occasion is less than or equal to a threshold period.

28. The method of claim 18, wherein:
the first MUSIM gap occasion collides with the second MUSIM gap occasion;
the second MUSIM gap occasion collides with a fourth MUSIM gap occasion;
the first MUSIM gap occasion has a higher relative priority than the second MUSIM gap occasion, which has a higher relative priority than the fourth MUSIM gap occasion; and
the method further comprises:
communicating with the UE during a period excluding the first MUSIM gap occasion and the fourth MUSIM gap occasion.

29. An apparatus for wireless communication by a user equipment (UE), comprising:
a memory comprising executable instructions; and
a processor configured to execute the executable instructions and cause the apparatus to:
detect a collision between a first multiple universal subscriber identity module (MUSIM) gap occasion and at least one of a second MUSIM gap occasion or a measurement gap (MG) occasion; and
process signals in at least one of the first MUSIM gap occasion, the second MUSIM gap occasion, a third MUSIM gap occasion, or the MG occasion based on relative priorities of the first MUSIM gap occasion, the second MUSIM gap occasion, or the MG occasion.

30. An apparatus for wireless communication by a network entity, comprising:
a memory comprising executable instructions; and
a processor configured to execute the executable instructions and cause the apparatus to:
detect a collision between a first multiple universal subscriber identity module (MUSIM) gap occasion configured for a user equipment (UE) and at least one of a second MUSIM gap occasion or a measurement gap (MG) occasion configured for the UE; and
schedule communications with the UE during a period excluding at least one of the first MUSIM gap occasion, the second MUSIM gap occasion, a third MUSIM gap occasion, or the MG occasion.
